(19) United States
(12) Patent Application Publication
(10) Pub. No.: US 2020/0129983 A1
(43) Pub. Date: Apr. 30, 2020

(54) SYSTEMS FOR THE CONTROL OF VALVELESS MICROFLUIDIC DEVICES USING ROTATIONAL AND PISTONING MOTION

(71) Applicant: TOKITAE LLC, Bellevue, WA (US)

(72) Inventors: Luis F. Alonzo, Tacoma, WA (US); Ryan Calderon, Seattle, WA (US); Michael Friend, Seattle, WA (US); Anne-Laure M. Le Ny, Issaquah, WA (US); Andrew Kuehl Miller, Seattle, WA (US); Kevin Paul Flood Nichols, Issaquah, WA (US)

(21) Appl. No.: 16/173,052

(22) Filed: Oct. 29, 2018

(51) Int. Cl. B01L 9/00; G01N 35/04

(52) U.S. Cl. CPC B01L 9/527; G01N 35/04; G01N 2035/0439; B01L 2300/041; B01L 2200/027

(57) ABSTRACT

Controlling a valveless microfluidic device using rotational and pistoning motion is disclosed. A system embodiment includes, but is not limited to, a stage to support a valveless microfluidic device, the stage having a bottom surface coupled with an extension, having a threaded portion, and defining an interior volume; a first motor including a powered rotating portion operable to engage with the threaded portion to induce a z-axis motion of the stage; a second motor including a powered rotating portion coupled with a slidable coupler, the slidable coupler engaging the interior volume to induce a second motion of the stage about the z-axis; a base defining an aperture to receive the stage; and a lid having a subset of the plurality of apertures corresponding to a subset of a plurality of apertures defined by the valveless microfluidic device upon positioning of the stage by the first motor and the second motor.

If an Application Data Sheet (ADS) has been filed on the filing date of this application, it is incorporated by reference herein. Any applications claimed on the ADS for priority under 35 U.S.C. §§ 119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority Application(s)).

### PRIORITY APPLICATIONS

None.

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### SUMMARY

In an aspect, a system includes, but is not limited to, a stage having an upper surface of a size and a shape to support a valveless microfluidic device, the stage having a bottom surface coupled with an extension extending from the bottom surface, the extension having a threaded portion on an exterior surface of the extension, the extension defining an interior volume; a first motor including a powered rotating portion operable to engage with the threaded portion of the extension of the stage to induce a z-axis motion of the stage in response to rotation of the powered rotating portion; a second motor including a powered rotating portion coupled with a slidable coupler, the slidable coupler engaging the interior volume of the extension of the stage to induce a second motion of the stage about the z-axis in response to rotation of the powered rotating portion of the second motor; a base coupled with the first motor and the second motor, the base defining an aperture to receive the stage within at least a portion of the aperture; and a lid moveably coupled to the base, the lid positionable to cover the aperture of the base in a closed position, the lid defining a plurality of apertures, a subset of the plurality of apertures corresponding to a subset of a plurality of apertures defined by the valveless microfluidic device upon positioning of the stage by the first motor and the second motor.

In an aspect, a system includes, but is not limited to, a valveless microfluidic device having a top planar surface and a bottom planar surface, a plurality of fluid inlet ports and a plurality of fluid outlet ports in the top planar surface and in fluid communication with a flow channel passing between the top planar surface and the bottom planar surface; and a fluid handling system having a stage having an upper surface of a size and a shape to support the valveless microfluidic device, the stage having a bottom surface coupled with an extension extending from the bottom surface, the extension having a threaded portion on an exterior surface of the extension, the extension defining an interior volume, a first motor including a powered rotating portion operable to engage with the threaded portion of the extension of the stage to induce a z-axis motion of the stage in response to rotation of the powered rotating portion, a second motor including a powered rotating portion coupled with a slidable coupler, the slidable coupler engaging the interior volume of the extension of the stage to induce a second motion of the stage about the z-axis in response to rotation of the powered rotating portion of the second motor, a base coupled with the first motor and the second motor, the base defining an aperture to receive the stage within at least a portion of the aperture, a lid moveably coupled to the base, the lid positionable to cover the aperture of the base in a closed position, the lid defining a plurality of apertures, a subset of the plurality of apertures corresponding to a subset of each of the plurality of fluid inlet ports and the plurality of fluid outlet ports upon positioning of the stage by the first motor and the second motor.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1A illustrates a system for control of valveless microfluidic devices.

FIG. 1B illustrates an isometric view of the system of FIG. 1A with connected fluid lines and a valveless microfluidic device positioned on a stage of the system.

FIG. 2A illustrates a top view of an embodiment of a valveless microfluidic device.

FIG. 2B illustrates a top view of an embodiment of a valveless microfluidic device with a transparent top surface shown.

FIG. 3A illustrates a top view of an embodiment of a manifold of a lid of a system for control of valveless microfluidic devices.

FIG. 3B illustrates a top view the manifold shown in FIG. 3A positioned over the valveless microfluidic device shown in FIG. 2A, with the manifold shown transparently.

FIG. 3C illustrates a top view of the manifold shown in FIG. 3A positioned over the valveless microfluidic device shown in FIG. 2B, with the manifold shown transparently and with a transparent top surface of the valveless microfluidic device.

FIG. 4A illustrates an isometric view of an embodiment of a motor system engaged with a stage of the system shown in FIG. 1A.

FIG. 4B illustrates a cross-sectional view of a second motor of the motor system shown in FIG. 4A.

FIG. 4C illustrates an isometric view of the motor system shown in FIG. 4A imparting a z-axis motion to the stage.

FIG. 4D illustrates an isometric view of the motor system shown in FIG. 4A imparting a motion of the stage about the z-axis.

FIG. 5A illustrates a top view of an embodiment of a configuration of the manifold shown in FIG. 3A positioned over the valveless microfluidic device shown in FIG. 2B to permit sample input.

FIG. 5B illustrates a top view of an embodiment of sample fluid flow through the configuration shown in FIG. 5A.

FIG. 6A illustrates a top view of an embodiment of a configuration of the manifold shown in FIG. 3A positioned over the valveless microfluidic device shown in FIG. 2B to permit media input.

FIG. 6B illustrates a top view of an embodiment of media fluid flow through the configuration shown in FIG. 6A.

FIG. 7A illustrates a top view of an embodiment of a configuration of the manifold shown in FIG. 3A positioned over the valveless microfluidic device shown in FIG. 2B to permit media output.

FIG. 7B illustrates a top view of an embodiment of media fluid flow through the configuration shown in FIG. 7A.

FIG. 8A illustrates a top view of an embodiment of a configuration of the manifold shown in FIG. 3A positioned over the valveless microfluidic device shown in FIG. 2B to permit introduction of fluid containing a bacteriophage.

FIG. 8B illustrates a top view of an embodiment of flow of fluid containing a bacteriophage through the configuration shown in FIG. 8A.

FIG. 9A illustrates a top view of an embodiment of a configuration of the manifold shown in FIG. 3A positioned over the valveless microfluidic device shown in FIG. 2B to permit lysate concentration within the valveless microfluidic device.

FIG. 9B illustrates a top view of an embodiment of flow of atmospheric fluid through the configuration shown in FIG. 9A.

FIG. 10A illustrates a top view of an embodiment of a configuration of the manifold shown in FIG. 3A positioned over the valveless microfluidic device shown in FIG. 2B to permit introduction of fluid containing a substrate.

FIG. 10B illustrates a top view of an embodiment of flow of fluid containing a substrate through the configuration shown in FIG. 10A.

FIG. 11A illustrates a partial isometric view of an embodiment of an indexing system of the system shown in FIG. 1A.

FIG. 11B illustrates a partial isometric view of an embodiment of an indexing system of the system shown in FIG. 1A.

FIG. 12 illustrates an isometric view of an embodiment of a motor system to position a stage.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Systems are described herein for providing positional control of a valveless microfluidic device having a plurality of inlet and outlet ports, where control is facilitated through pistoning and rotation of a stage on which the valveless microfluidic device is supported. Positioning of the stage is controlled and modified through operation of one or more motors. Rotational motion of the stage aligns one pair of ports of the valveless microfluidic device (e.g., an inlet and corresponding outlet) with corresponding ports of a manifold positioned over the valveless microfluidic device. The manifold provides an interface to receive fluids for introduction to, and suction sources to draw fluids from, the valveless microfluidic device. Pistoning of the stage creates a seal between the valveless microfluidic device and the manifold when the stage is moved in a z direction to press the valveless microfluidic device against a lid supporting the manifold. In this position, a specified fluid flow path through the valveless microfluidic device is completed and access to all other ports on the valveless microfluidic device is restricted. Rotation of the stage to a different alignment position aligns different ports of the manifold and the valveless microfluidic device to provide different flow paths through the valveless microfluidic device (e.g., to facilitate different steps of an assay for bacterial detection).

Such operational control of the stage provides interaction of specific ports of the manifold and the valveless microfluidic device without use of valves on the valveless microfluidic device or the manifold. Such valves can increase the cost, required space, and complexity of the microfluidic platforms that rely on valve timing to control fluid flow during assays or other operations, limiting their availability and usefulness. Other microfluidic devices provide fluid flow through the devices via centrifugal force. For example, fluids can be introduced to a center region of the device and a spinning motion is imparted to direct the flow of flow outward, such as through fluid channels connected to the center region. In implementations, the systems described herein facilitate detection of bacteria in liquid populations, where use of a valveless microfluidic device and corresponding systems permit in-field analysis of water or other fluids available to communities on-site or nearby. These systems are rotated to align ports between the manifold and the valveless microfluidic device to facilitate an assay having six process flow steps that require specific microfluidic areas of the device be in use in each step, rather than to utilize centrifugal force to facilitate fluid flow through the device.

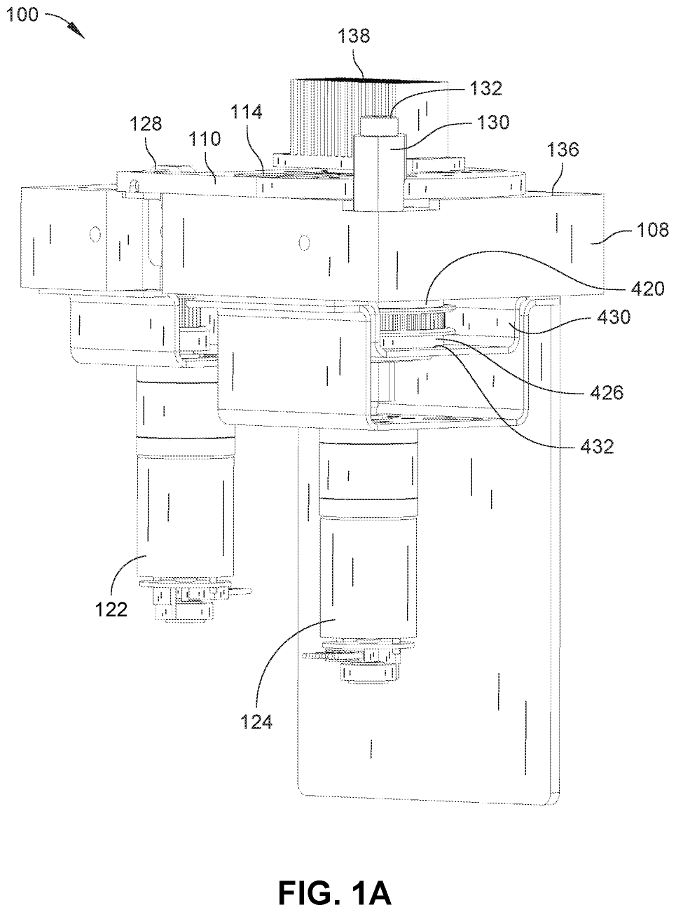

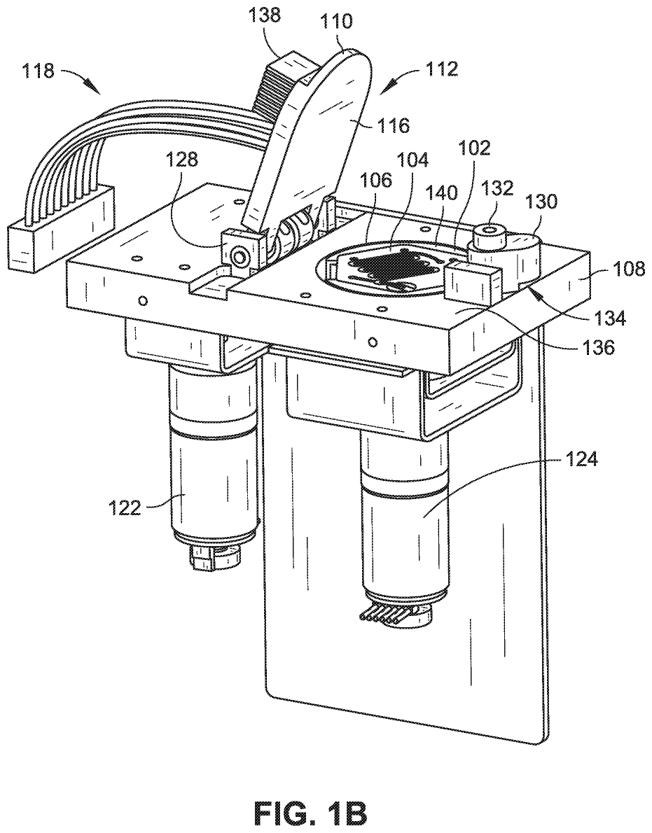

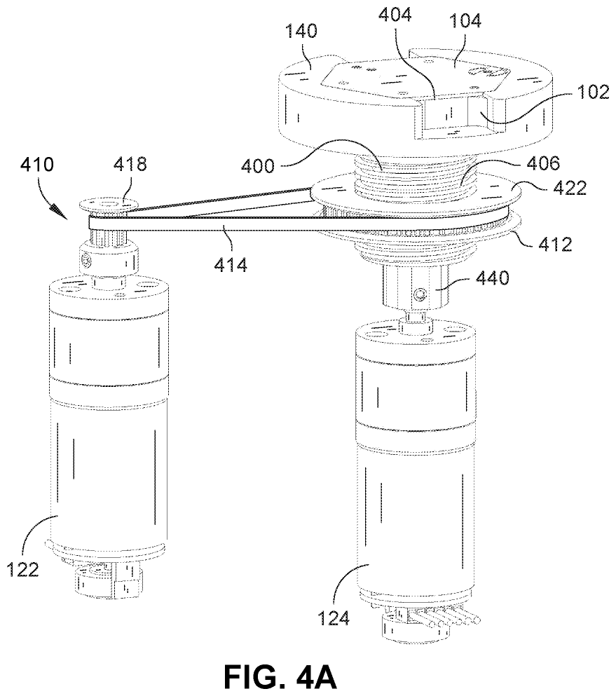

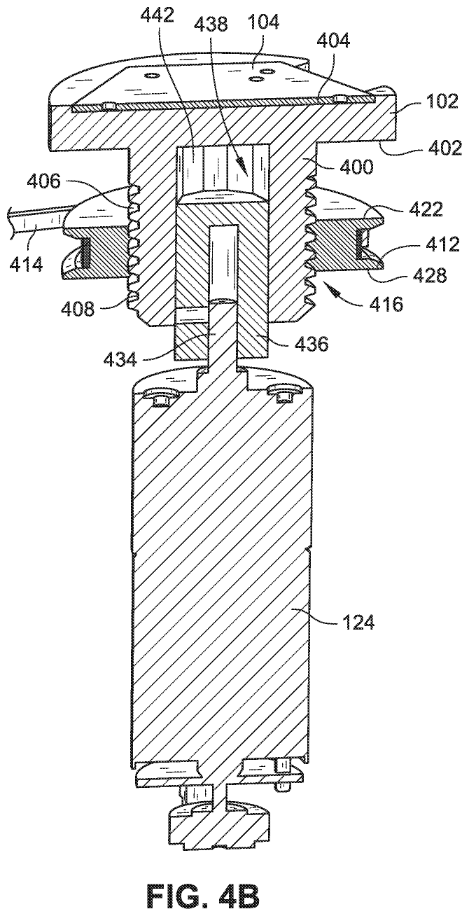

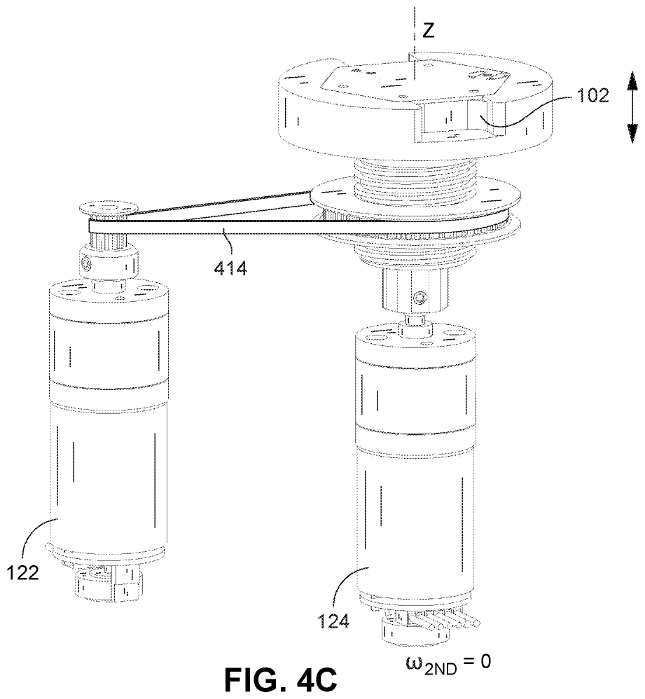

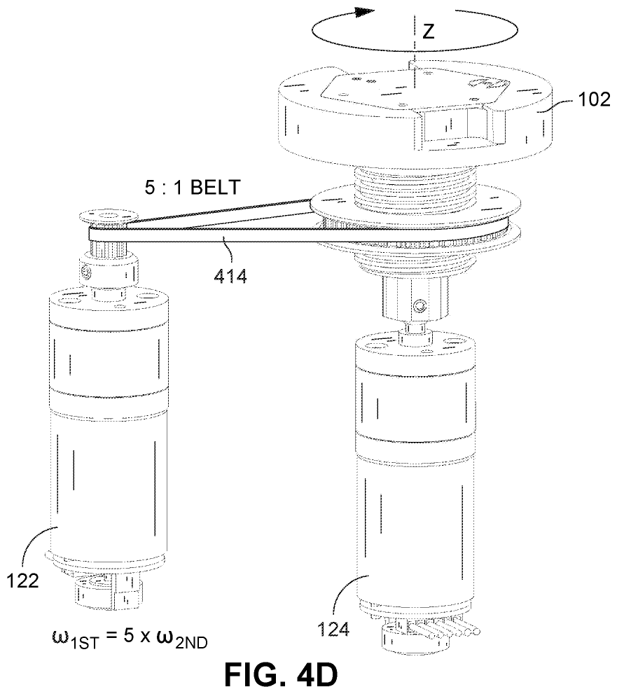

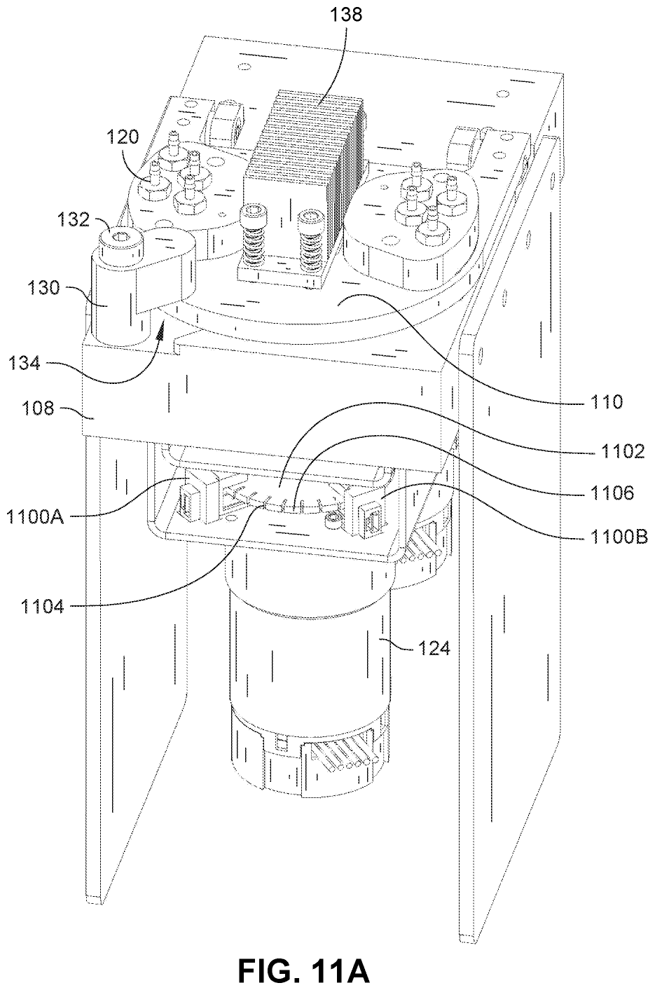

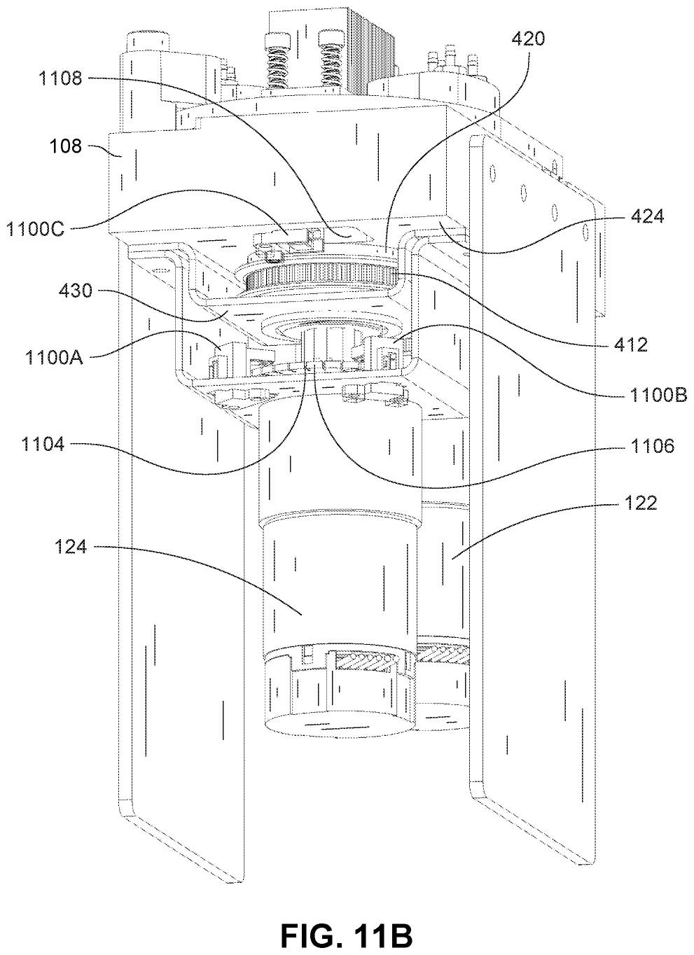

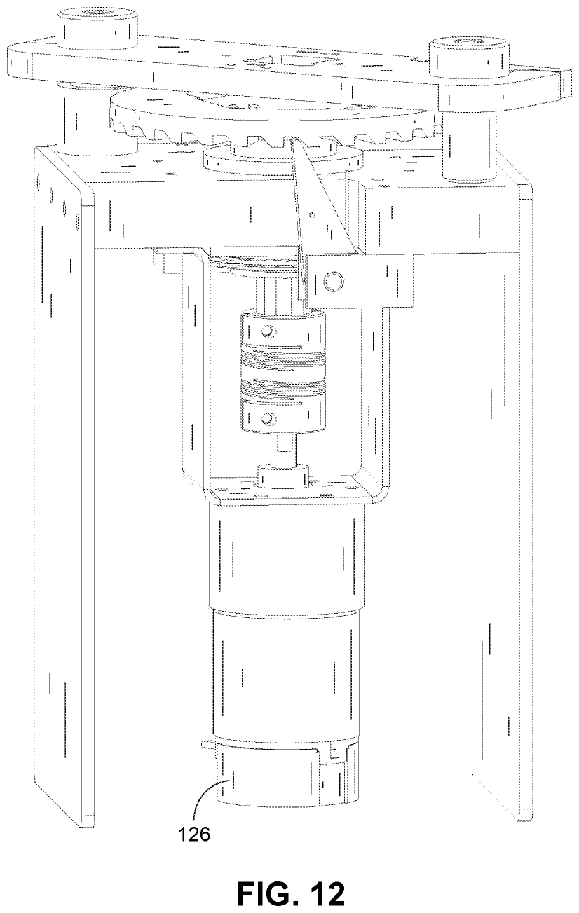

Referring to FIGS. 1A and 1B, an example system 100 for providing positional control of a valveless microfluidic device is shown, which can serve as context for one or more devices and/or systems described herein. The system 100 includes a stage 102 supporting a valveless microfluidic device 104 within an aperture 106 defined by a base 108. The base 108 supports a lid 110 defining a manifold with a plurality of ports 112 extending between an upper surface 114 and a lower surface 116 of the lid 110. One or more ports of the plurality of ports 112 are coupled to one or more fluid lines 118 (e.g., via fluid line connectors 120 shown in FIG. 11A) to supply fluids to and from the valveless microfluidic device 104, to provide an interface between one or more suction sources and the valveless microfluidic device 104 (e.g., to draw fluids out from the valveless microfluidic device 104), or combinations thereof. The system 100 includes a motor system to control positioning of the stage 102 and the valveless microfluidic device 104 positioned thereon. In some embodiments, an example of which is shown in FIGS. 1A and 1B, the motor system includes a first motor 122 and a second motor 124 utilized to provide z-axis motion, motion about or about the z-axis, or combinations thereof. Further description of the operation of the first motor 122 and the second motor 124 to control positioning of the stage 102 is provided with respect to FIGS. 4A through 4D. In some embodiments, an example of which is shown in FIG. 12, the motor system includes a single motor 126.

The lid 110 is moveably coupled to the base 108, where the lid 110 can move between a first or open position (e.g., shown in FIG. 1B) and a second or closed position (e.g., shown in FIG. 1A). In the second or closed position, the lid 110 covers the aperture 106 defined by the base 108 to bring the plurality of apertures 112 adjacent to the valveless microfluidic device 104. For example, the lid 110 can rotate about a hinge mount 128 coupled to the base 108 to rotate between the first or open position and the second or closed position. While the system 100 is shown with the hinge mount 128, the system 100 can include additional or alternative mounting schemes including, but not limited to, a slidable coupling wherein the lid 110 is slidably coupled to the base 108 via at least one groove, or other mounting scheme. In some embodiments, the system 100 can include a securing device to maintain the lid 110 in the second or closed position. For example, the system 100 is shown with a securing fastener 130 having a size and shape to secure at least a portion of the lid 110 against the base 108 when the lid 110 is in the closed position. The securing fastener 130 can be coupled to the base 108 via a pin 132 which defines an axis of rotation for a body portion of the securing fastener 130. The securing fastener 130 further defines a gap 134 between a top surface 136 of the base 108 and the body portion of the securing fastener 130 where the gap 134 has a size and shape to fix at least a portion of the lid 110 within the gap 134 when the securing fastener 130 is positioned over the lid 110 in the second or closed position (e.g., via rotation of the securing fastener 130 about the pin 132 when the lid 110 is in the second or closed position).

In some embodiments, the system 100 can facilitate temperature control to maintain or alter a temperature of the valveless microfluidic device 104 supported by the stage 102. For example, the system 100 can include a thermal regulation device 138 coupled to the lid 110. At a least a portion of the thermal regulation device 138 can be coupled to the top surface 114 of the lid 110 such that when the lid 110 is in the second or closed position, the thermal regulation device 138 is positioned adjacent the aperture 106 in the base 108. The thermal regulation device 138 can include, but is not limited to, a heat sink, a thermoelectric cooler, or combinations thereof.

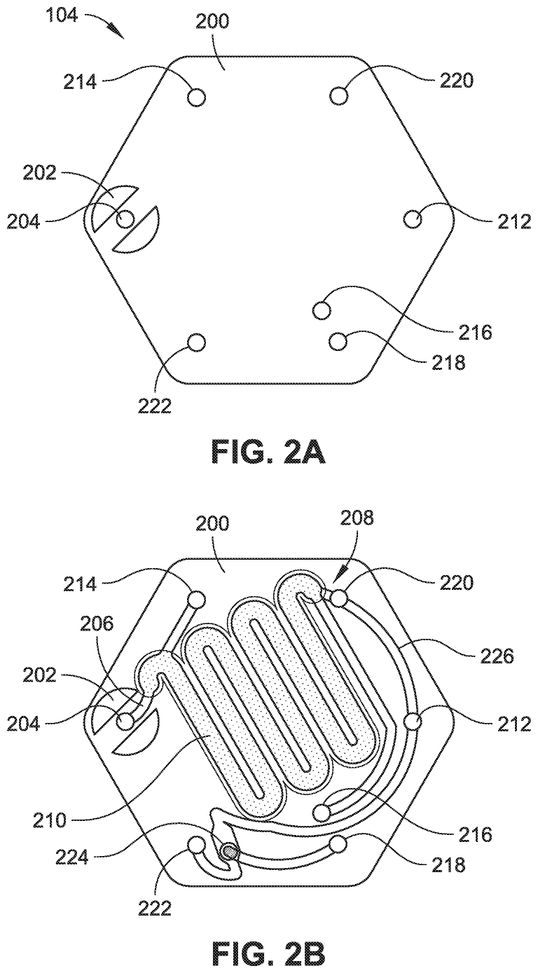

Referring to FIGS. 2A and 2B, an example valveless microfluidic device 104 is shown. FIG. 2A shows a top view of the valveless microfluidic device 104. The valveless microfluidic device 104 includes a top planar surface 200 and a bottom planar surface (under the top planar surface in this view), at least one aperture 202 passing entirely through the valveless microfluidic device 104 (an embodiment of two apertures 202 are shown), and a sample inlet aperture 204 in the top planar surface 200 and in fluid communication with a flow channel 206 (shown in FIG. 2B) passing between the top planar surface 200 and the bottom planar surface of the valveless microfluidic device 104. The sample inlet aperture 204 can be centrally positioned relative to the at least one aperture 202. FIG. 2B shows a top view of the valveless microfluidic device 104 with the top planar surface 200 shown transparently. The valveless microfluidic device 104 includes a network or set of micro-channels 208 in fluid communication with the sample inlet aperture 204 and the flow channel 206 and is at least partially positioned between the top planar surface 200 and the bottom planar surface of the valveless microfluidic device 104. The valveless microfluidic device 104 can include features for directing, moving, mixing, separating, and otherwise processing a sample liquid and its contents. For example, the valveless microfluidic device 104 can include a membrane 210 in fluid communication with the sample inlet aperture 204 and the flow channel 206 to separate one or more contents of a sample liquid. The membrane 210 can include, but is not limited to, a bacteria capture membrane. The membrane 210 can form a portion of, be included at least partially within, or otherwise be associated with at least a portion of the network or set of micro-channels 208. The network or set of micro-channels 208 can be patterned to achieve a desired feature or features (e.g., lab-on-a-chip, cell culture, pathogen detection, electrophoresis, DNA analysis, and the like). The valveless microfluidic device 104 can include features to attain multiplexing, automation, and/or high-throughput analysis. For example, the valveless microfluidic device 104 can include features for assaying for the presence or absence of a target analyte (e.g., pathogen, biomarker, or contaminant) in a liquid (e.g., water, blood, urine, or other fluid). The network or set of micro-channels 208 can be etched or molded into a material (e.g., glass, silicon, metal, metal alloy, or polymer such as polydimethylsiloxane (PDMS), polystyrene, polymethylmethacrylate (PMMA), or polycarbonate). The network or set of micro-channels 208 can be connected or networked together to achieve desired features (e.g., mix, pump, sort, and/or control the biochemical environment). The network or set of micro-channels 208 within the microfluidic device can be in fluid communication with external active systems (e.g., pressure controllers, push-syringe, or peristaltic pump) or passive systems (e.g., hydrostatic pressure).

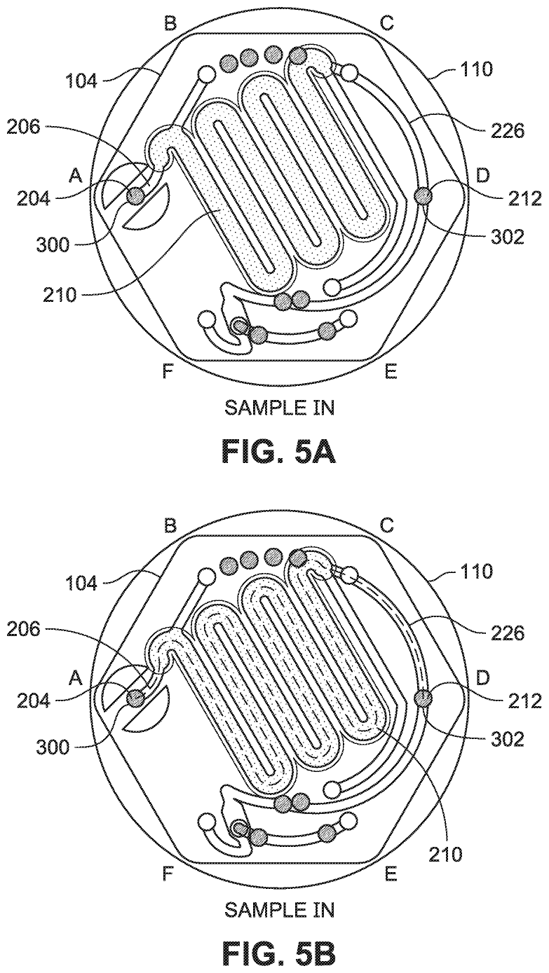

The valveless microfluidic device 104 of the system 100 has a size and a shape to accommodate the network or set of micro-channels 208 at least partially positioned between the top planar surface 200 and the bottom planar surface and to accommodate the at least one aperture 202 passing through the valveless microfluidic device 104. In the non-limiting example of FIGS. 2A and 2B, the valveless microfluidic device 104 is hexagonal in shape. However, the valveless microfluidic device 104 of the system 100 can take other forms, including but not limited to, circular, oval, triangular, square, rectangular, or polygonal in shape. In some embodiments, the valveless microfluidic device 104 has an irregular shape. In some embodiments, the stage 102 includes a support wall 140 (e.g., shown in FIGS. 1B and 4A) arranged around at least a portion of a top surface (e.g., 404 shown in FIGS. 4A and 4B) of the stage 102. The support wall 140 has a size and shape to friction fit the valveless microfluidic device 104 on the top surface 404 of the stage 102 such that motion of the stage 102 controls motion of the valveless microfluidic device 104 thereon. For example, at least a portion of a perimeter (e.g., a corner) of the valveless microfluidic device 104 interacts with the support wall 140 to friction fit the valveless microfluidic device 104 onto the stage 102. In some embodiments, the stage 102 includes a projection extending from the top surface 404 of the stage 102 to conform to one or more positioning apertures (e.g., apertures 202) of the valveless microfluidic device 104 to facilitate keying of the valveless microfluidic device 104 in a particular orientation on the stage 102. For example, the orientation of the valveless microfluidic device 104 on the stage 102 can affect whether a particular series of operations of the system 100 provide the proper alignment of ports on the lid 110 and the valveless microfluidic device 104. In some embodiments, the projection extending from the top surface 404 of the stage 102 aligns with one or more of the apertures 202 to key the valveless microfluidic device 104 on the stage 102, which when the system 100 recognizes the positioning of the stage 102 (e.g., with indexing sensors described with reference to FIGS. 11A and 11B), the system 100 can ensure that the valveless microfluidic device 104 is in the proper alignment for a given series of operations (e.g., one or more operations described with reference to FIGS. 5A through 10B).

The valveless microfluidic device 104 generally has a thickness to accommodate the network or set of micro-channels 208 at least partially positioned between the top planar surface 200 and the bottom planar surface. In some embodiments, the valveless microfluidic device 104 is about 1 millimeter thick. In some embodiments, the valveless microfluidic device 104 is about 0.5 millimeters to about 5 millimeters thick. In some embodiments, the valveless microfluidic device 104 is as thick as 10 millimeters. For example, the valveless microfluidic device 104 can be about 0.5 millimeters, 0.6 millimeters, 0.7 millimeters, 0.8 millimeters, 0.9 millimeters, 1 millimeter, 1.5 millimeters, 2 millimeters, 2.5 millimeters, 3 millimeters, 3.5 millimeters, 4 millimeters, 4.5 millimeters, 5 millimeters, 5.5 millimeters, 6 millimeters, 6.5 millimeters, 7 millimeters, 7.5 millimeters, 8 millimeters, 8.5 millimeters, 9 millimeters, 9.5 millimeters, or 10 millimeters thick. In some embodiments, the valveless microfluidic device 104 is about 0.875 millimeters thick.

Returning to FIGS. 2A and 2B, the valveless microfluidic device 104 includes a plurality of inlet and outlet ports through the top planar surface 200 and in fluid communication with the network or set of micro-channels 208 to interface with the plurality of ports 112 in the lid 110 to introduce fluids to or remove fluids from the valveless microfluidic device 104 during operation of the system 100. The valveless microfluidic device 104 is shown having the sample inlet aperture 204, a second aperture 212, a third aperture 214, a fourth aperture 216, a fifth aperture 218, a sixth aperture 220, and a seventh aperture 222, at least a subset of which are fluidically connected by the network or set of micro-channels 208. The valveless microfluidic device 104 is also shown having an enzyme reporter capture membrane 224 (shown in FIG. 2B) in fluid communication with the network or set of micro-channels 208. For example, the enzyme reporter capture membrane 224 can be positioned along a flow channel 226 where the second aperture 212 and the sixth aperture 220 are positioned between the membrane 210 and the enzyme reporter capture membrane 224 along the flow channel 226.

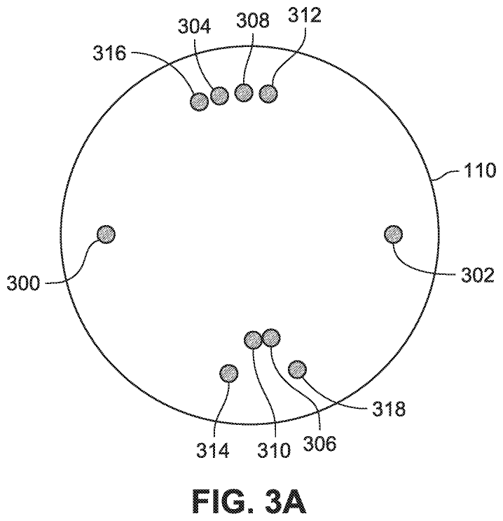

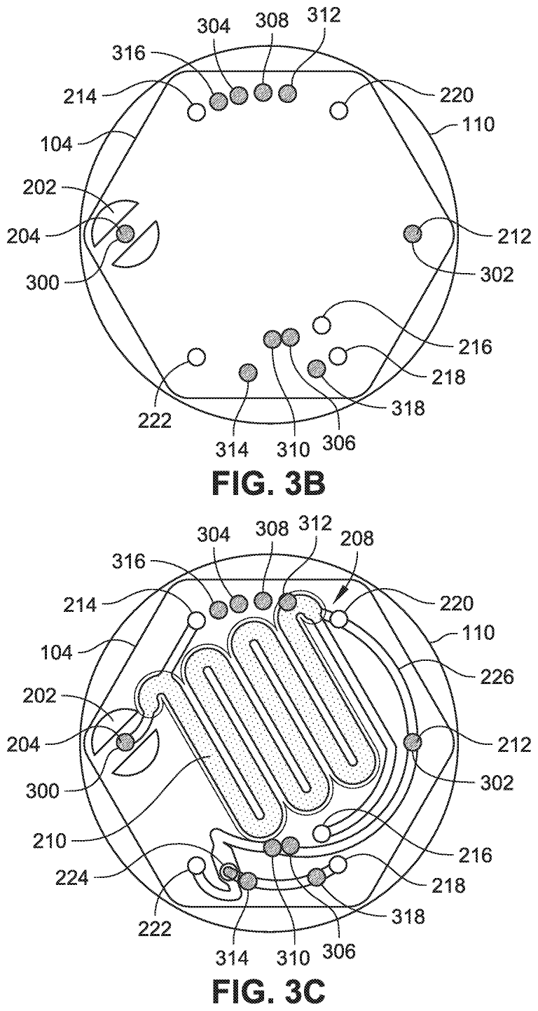

During operation of the system 100, the motor system manipulates positioning of the stage 102 and the valveless microfluidic device 104 positioned thereon to align two ports of the valveless microfluidic device 104 with two corresponding ports of the plurality of ports 112 in the lid 110 at a given time to permit fluids to be introduced to or from the valveless microfluidic device 104 via one or more fluid lines 118 through application of suction to one or more fluid lines 118. An example arrangement of the plurality of ports 112 in the lid 110 is shown in FIG. 3A, where the lid 110 includes a first aperture 300, a second aperture 302, a third aperture 304, a fourth aperture 306, a fifth aperture 308, a sixth aperture 310, a seventh aperture 312, an eighth aperture 314, a ninth aperture 316, and a tenth aperture 318. Referring to FIGS. 3B and 3C, an example positioning of the valveless microfluidic device 104 is shown with respect to the lid 110 to align aperture 204 of the valveless microfluidic device 104 with aperture 300 of the lid 110 and to align aperture 212 of the valveless microfluidic device 104 with aperture 302 of the lid 110. In such positioning, the lid 110 is in the second or closed position with respect to the aperture 106 in the base 108 to position the lid 110 adjacent the valveless microfluidic device 104 on the stage 102. Other example alignments of the ports of the lid 110 and the ports of the valveless microfluidic device 104 are described with reference to FIGS. 5A through 10B in an example bacterial assay facilitated by the system 100.

Referring to FIGS. 4A through 4D, operation of the first motor 122 and the second motor 124 to control positioning of the stage 102 is shown in accordance with example embodiments. The stage 102 includes an extension 400 extending from a bottom surface 402 of the stage 102 opposite a top surface 404 of the stage 102 that supports the valveless microfluidic device 104. The extension 400 is dimensioned and structured to interact with the first motor and the second motor 124 to facilitate rotational and pistoning motion of the stage 102. For example, the extension 400 is shown with a threaded portion 406 on an exterior surface 408 of the extension 400. The threaded portion 406 can include, but is not limited to, ACME threading. The first motor 122 includes a powered rotating portion 410 operable to engage with the threaded portion 406 of the extension 400 to induce a z-axis motion of the stage 102 (e.g., pistoning of the stage 102) when the first motor 122 drives (e.g., spins) the powered rotating portion 410. In some embodiments, the powered rotating portion 410 is operably coupled to the threaded portion 406 through a pulley 412 and a belt 414. The pulley 412 includes an interior surface that defines an aperture 416 having a threading pattern that corresponds to the threaded portion 406 of the extension 400. The belt 414 is coupled between the pulley 412 and the first motor 122 such that motion of the powered rotating portion 410 is translated by the belt 414 to the pulley 412, where the interior threading of the pulley 412 interacts with the threaded portion 406 of the extension 400 to move the stage 102 along a z-axis extending through the top surface 404. For instance, the pulley 412 can remain fixed along the z-axis to raise or lower the stage 102 along the z-axis through interaction between the threading pattern of the pulley 412 and the threaded portion 406 of the extension 400. In some embodiments, the powered rotating portion 410 includes a rotatable gear 418 coupled to the belt 414 to spin the pulley 412 upon operation of the first motor 122. In some embodiments, the powered rotating portion 410 directly interfaces with the extension 400 (e.g., without a belt and pulley), such as through direct interaction between the rotatable gear 418 and the extension 400.

In some embodiments, the system 100 includes bearings and mounts to keep the pulley 412 fixed along the z-axis. For example, the system 100 can include a first bearing 420 (shown in FIGS. 1A and 11B) positioned between a top surface 422 of the pulley 412 and a bottom surface 424 of the base 108 and a second bearing 426 positioned on a bottom surface 428 of the pulley 412. In some embodiments, the first bearing 420 is in contact with each of the top surface 422 of the pulley 412 and the bottom surface 424 of the base 108, and the second bearing is in contact with the bottom surface 428 of the pulley 412 to restrict a vertical movement of the pulley 412 (e.g., along the z-axis) during operation of the first motor 122, the second motor 124, or each of the first motor 122 and the second motor 124. In some embodiments, the system 100 includes a mount to support the pulley 412 with respect to the base 108. For example, the system 100 can include a pulley support or bracket 430 that supports a bottom surface 432 of the second bearing 426 with respect to the base 408. In some embodiments, the pulley support or bracket 430 (shown in FIGS. 1A and 11B) is coupled to the base 108, such as through a fastener coupled to the bottom surface 424 of the base 108.

The second motor 124 includes a powered rotating portion 434 coupled with a slidable coupler 436 that engages the extension 400 of the stage 102 to induce a second motion of the stage about the z-axis (e.g., a rotational motion about the z-axis) in response to rotation of the powered rotating portion 434 of the second motor 124. For example, the extension 400 can define an internal volume 438 into which the slidable coupler 436 is inserted, where the internal volume 438 and the slidable coupler 436 are complementarily structured such that rotational motion of the slidable coupler 436 (e.g., applied through the powered rotating portion 434) imparts rotational motion to the extension 400 and corresponding stage 102. In some embodiments, the slidable coupler 436 includes one or more facets 440 and the internal volume 438 of the extension 400 includes one or more complementary facets 442 of a size and a shape to match the one or more facets 440 of the slidable coupler 436 when the slidable coupler 436 is received within the interior volume 438. In some embodiments, the powered rotating portion 434 defines a portion of, or is coupled to, a shaft of the second motor 124 that rotates upon operation of the second motor 124.

The stage 102 undergoes movement along the z-axis through operation of the first motor 122. For example, as shown in FIG. 4C, the first motor 122 operates (e.g., under application of power to the first motor 122) to spin the powered rotating portion 410 and corresponding belt 414 and pulley 412 to permit the threading pattern of the pulley 412 to engage with the threaded portion 406 of the extension 400. When the powered rotating portion 434 of the second motor 124 is held fixed (e.g., no power introduced to the second motor 124), movement of the powered rotating portion 410 of the first motor 122 induces the z-axis motion of the stage 102. When the powered rotating portion 434 of the second motor 124 is held fixed, rotation of the powered rotating portion 410 in a first direction by the first motor 122 causes motion of the stage 102 in a first direction (e.g., causing the stage 102 to be lowered), whereas rotation of the powered rotating portion 410 in a second direction by the first motor 122 causes motion of the stage 102 in a second direction (e.g., causing the stage 102 to be raised). The internal volume 438 of the extension 400 can have a size and shape sufficient to permit vertical translation of the slidable coupler 436 within the internal volume 438 during z-axis motion of the stage 102. Rotational motion of the stage 102 is facilitated through operation of the second motor 124. The system 100 can facilitate a rotational motion of the stage 102 without the z-axis motion of the stage 102 when the first motor 122 and the second motor 124 induce controlled rotational rates of the powered rotating portion 410 and the powered rotating portion 434. Such controlled rotational rates can depend on whether the system 100 includes the belt 414 for a gear reduction with respect to the powered rotating portion 410 and the powered rotating portion 434. For example, as shown in FIG. 4D, the first motor 122 spins the powered rotating portion 410 at an angular rate that is five times that of the powered rotating portion 434 spun by the second motor 124 when the belt 414 provides a 5:1 belt reduction. As such, the belt 414 moves at the same angular rate as the powered rotating portion 434 of the second motor 124. Such motor control provides no relative thread motion between the threading pattern of the pulley 412 and the threaded portion 406 of the extension 400, providing no z-axis motion of the stage 102 while providing rotational motion of the stage 102 about the z-axis. While a 5:1 belt reduction is shown, the belt 414 is not limited to such reduction and can include reductions of less than 5:1 or more than 5:1. When the first motor 122 and the second motor 124 operate to rotate the powered rotating portion 410 and the powered rotating portion 434 at angular rates of rotation that differ from each other by a ratio other than the ratio of belt reduction, then the motor system provides each of the z-axis motion and the rotational motion about the z-axis of the stage 102. As such, operation of each of the first motor 122 and the second motor 124 can cause rotational motion about the z-axis of the stage 102 or can cause each of rotational motion about the z-axis of the stage 102 and z-axis motion of the stage 102, where such motion can depend on the particular coupling between the powered rotating portion 410 and the extension 400. In some embodiments, the system 100 includes a motor with an internal annulus having threads thereon, where the motor drives the thread motion to interact with the threaded portion 406 of the extension 400 to move the stage 102 along the z-axis.

The direction of rotation of the stage 102 can be facilitated through coordinated rotation of each of the powered rotating portion 410 and the powered rotating portion 434. For example, the first motor 122 is operable to rotate the powered rotating portion 410 in a first direction and the second motor 124 is operable to rotate the powered rotating portion 434 in the first direction to rotate the stage 102 in a clockwise direction, whereas the first motor 122 is operable to rotate the powered rotating portion 410 in a second direction and the second motor 124 is operable to rotate the powered rotating portion 434 in the second direction to rotate the stage 102 in a counterclockwise direction. The stage 102 can also be raised or lowered while being simultaneously rotated depending on the angular rates of rotation of the powered rotating portion 410 and the powered rotating portion 434. For example, in embodiments, the first motor 122 is operable to rotate the powered rotating portion 410 in a first direction and the second motor 124 is operable to rotate the powered rotating portion 434 in the first direction to rotate the stage 102 in a clockwise and first vertical direction, whereas the first motor 122 is operable to rotate the powered rotating portion 410 in a second direction and the second motor 124 is operable to rotate the powered rotating portion 434 in the second direction to rotate the stage 102 in a counterclockwise and second vertical direction (e.g., opposite the first vertical direction).

An example operation of the system 100 is described with reference to FIGS. 5A through 10B where rotation of the stage 102 by the first motor 122 aligns different ports of valveless microfluidic device 104 with corresponding ports of the lid 110. The lid 110 provides an interface to receive fluids for introduction to, and suction sources to draw fluids from, the valveless microfluidic device 104 (e.g., through the fluid lines 118 coupled to fluid line connectors 120). Pistoning of the stage 102 through operation of each of the first motor 122 and the second motor 124 creates a seal between the valveless microfluidic device 104 and the lid 110 when the stage 102 is moved in the z-axis direction to press the valveless microfluidic device 104 against the lower surface 116 of the lid 110 (e.g., or a sealing flange disposed thereon). When the valveless microfluidic device 104 is sealed against the lid 110 with ports aligned, a specified fluid flow path through the valveless microfluidic device 104 is completed and access to all other ports on the valveless microfluidic device 104 is restricted until the stage 102 is repositioned. Rotation of the stage 102 to a different alignment position aligns different ports of the lid 110 and the valveless microfluidic device 104 to provide different flow paths through the valveless microfluidic device 104. The system 100 can include a controller to control operation of the motor system to manipulate the positioning of the stage 102 relative to the lid 110 based on which ports should be aligned for each step of a controlled process. For example, the controller can activate the first motor 122 when z-axis motion of the stage 102 is included in the process (e.g., to transition the stage 102 between operation steps, to seal the stage 102 against the lid 110, etc.), and the controller can activate each of the first motor 122 and the second motor 124 when rotational motion (or rotational and z-axis motion) is included in the process (e.g., to transition the stage 102 between operation steps, to seal the stage 102 against the lid 110, etc.). In some embodiments, the controller controls operation of the first motor 122 and the second motor 124 to provide a rotation of the stage 102 that is less than approximately 5 revolutions per minute (RPM). For example, the rotational speed of the stage 102 during rotation does not substantially influence movement of fluids through the valveless microfluidic device 104, which is instead provided, for example, through interactions with one or more suction devices fluidically coupled with the lid 110.

Referring to FIGS. 5A and 5B, the valveless microfluidic device 104 is shown in a first position with respect to the lid 110 to facilitate sample introduction to the valveless microfluidic device 104. In the first position, the first aperture 300 of the lid 110 is aligned with and in fluid communication with the sample inlet aperture 204 of the valveless microfluidic device 104. The second aperture 302 of the lid 110 is aligned with and in fluid communication with the second aperture 212 of the valveless microfluidic device 104 when the valveless microfluidic device 104 is in the first position with respect to the lid 110. In some embodiments, the first aperture 300 of the lid 110 is coupled with a fluid line in fluid communication with a reagent source and the second aperture 302 of the lid 110 is coupled to a suction device (e.g., vacuum source, pump, etc.) via a second fluid line such that fluid is drawn from the reagent source through the first fluid line, through the sample inlet aperture 204 of the valveless microfluidic device 104, through at least a portion of the flow channel of the valveless microfluidic device 104 in response to application of suction to the second fluid line by the suction device. For example, a fluid sample can be drawn into the valveless microfluidic device 104 from the reagent source through action of the suction device, where the sample travels through the sample inlet aperture 204, into the flow channel 206, through the membrane 210, and into flow channel 226, where fluid portions of the sample can be removed through the alignment of the second aperture 212 of the valveless microfluidic device 104 the second aperture 302 of the lid 110, whereas species of interest (e.g., bacterial species of interest) can be retained within the valveless microfluidic device 104 through action of the membrane 210. In some embodiments, the fluid sample is loaded into the valveless microfluidic device 104 during a manual fill step with the valveless microfluidic device 104 removed from the stage 102.

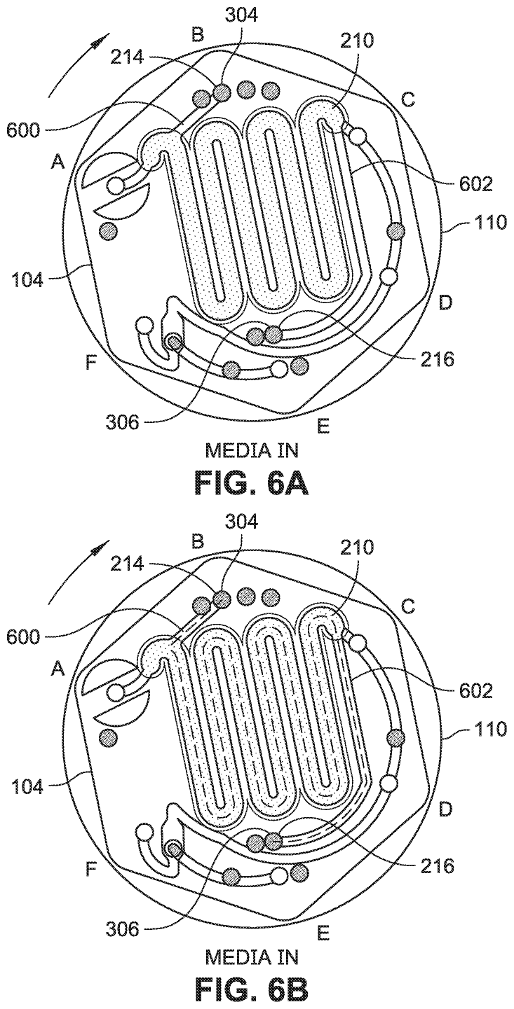

Referring to FIGS. 6A and 6B, the valveless microfluidic device 104 is shown in a second position with respect to the lid 110 to facilitate introduction of a microbial growth media to the valveless microfluidic device 104. In the second position, the third aperture 304 of the lid 110 is aligned with and in fluid communication with the third aperture 214 of the valveless microfluidic device 104. The fourth aperture 306 of the lid 110 is aligned with and in fluid communication with the fourth aperture 216 of the valveless microfluidic device 104 when the valveless microfluidic device 104 is in the second position with respect to the lid 110. In some embodiments, the third aperture 304 of the lid 110 is coupled with a fluid line in fluid communication with a reagent source (e.g., a source of microbial growth media) and the fourth aperture 306 of the lid 110 is coupled to a suction device (e.g., vacuum source, pump, etc.) via a second fluid line such that fluid is drawn from the reagent source through the first fluid line, through the third aperture 214 of the valveless microfluidic device 104, through at least a portion of the flow channel of the valveless microfluidic device 104 in response to application of suction to the second fluid line by the suction device. For example, a microbial growth media can be drawn into the valveless microfluidic device 104 from the reagent source through action of the suction device, where the microbial growth media travels through the third aperture 214, into a flow channel 600, through the membrane 210, and into a flow channel 602 in fluid communication with the fourth aperture 216 of the valveless microfluidic device 104 to provide microbial growth media within the membrane 210 (e.g., to interact with any bacterial species caught therein following introduction of the fluid sample). In embodiments, the system 100 transitions between the first position of the stage 102 and the second position of the stage 102 through a clockwise rotation of the stage 102 from the first position to the second position. Following introduction of the microbial growth media, the valveless microfluidic device 104 can be incubated to facilitate growth of bacteria retained by the membrane 210.

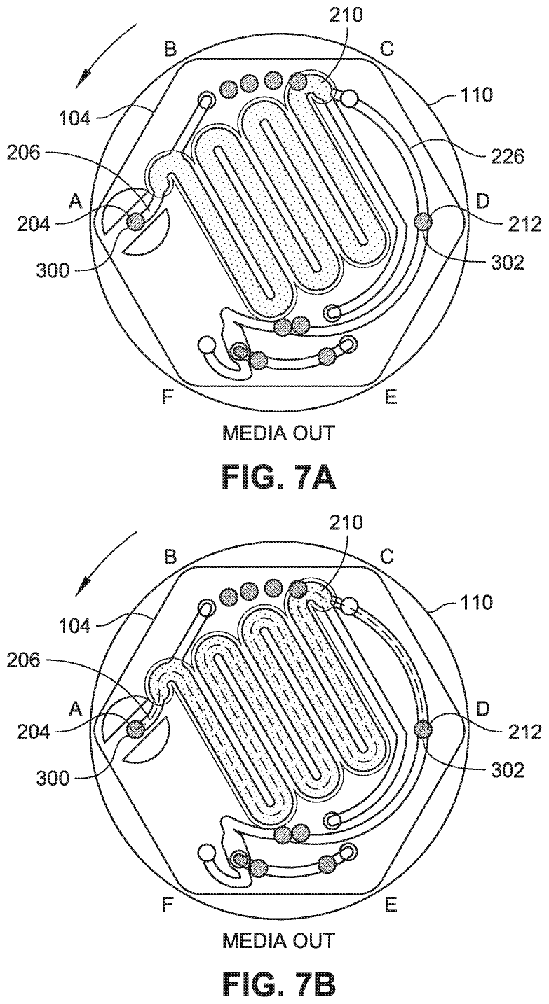

Referring to FIGS. 7A and 7B, the valveless microfluidic device 104 is shown returned to the first position with respect to the lid 110 to facilitate removal of microbial growth media from the valveless microfluidic device 104. As described above, in the first position, the first aperture 300 of the lid 110 is aligned with and in fluid communication with the sample inlet aperture 204 of the valveless microfluidic device 104, and the second aperture 302 of the lid 110 is aligned with and in fluid communication with the second aperture 212 of the valveless microfluidic device 104. In some embodiments, microbial growth media is removed from the valveless microfluidic device 104 through application of suction to the second aperture 302 of the lid 110. In embodiments, the system 100 transitions from the second position of the stage 102 to the first position of the stage 102 through a counterclockwise rotation of the stage 102 from the second position to the first position.

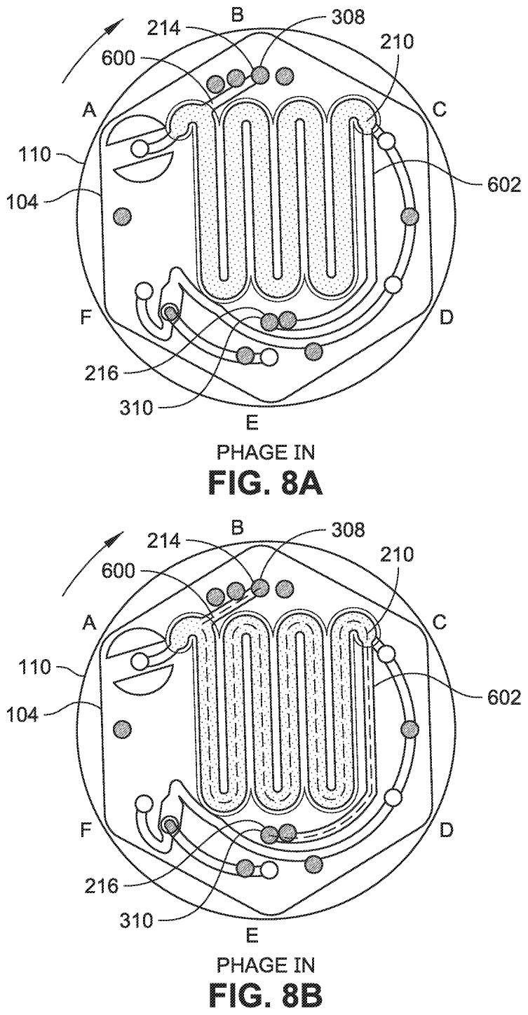

Referring to FIGS. 8A and 8B, the valveless microfluidic device 104 is shown in a third position with respect to the lid 110 to facilitate introduction of a fluid containing a bacteriophage to the valveless microfluidic device 104. In the third position, the fifth aperture 308 of the lid 110 is aligned with and in fluid communication with the third aperture 214 of the valveless microfluidic device 104. The sixth aperture 310 of the lid 110 is aligned with and in fluid communication with the fourth aperture 216 of the valveless microfluidic device 104 when the valveless microfluidic device 104 is in the third position with respect to the lid 110. In some embodiments, the fifth aperture 308 of the lid 110 is coupled with a fluid line in fluid communication with a reagent source (e.g., a fluid containing a bacteriophage) and the sixth aperture 310 of the lid 110 is coupled to a suction device (e.g., vacuum source, pump, etc.) via a second fluid line such that fluid is drawn from the reagent source through the first fluid line, through the third aperture 214 of the valveless microfluidic device 104, through at least a portion of the flow channel of the valveless microfluidic device 104 in response to application of suction to the second fluid line by the suction device. For example, a fluid containing a bacteriophage can be drawn into the valveless microfluidic device 104 from the reagent source through action of the suction device, where the fluid containing a bacteriophage travels through the third aperture 214, into the flow channel 600, through the membrane 210, and into the flow channel 602 in fluid communication with the fourth aperture 216 of the valveless microfluidic device 104 to provide the bacteriophage within the membrane 210 (e.g., to interact with any bacterial species caught therein following introduction of the fluid sample). In embodiments, the system 100 transitions between the first position of the stage 102 and the third position of the stage 102 through a clockwise rotation of the stage 102 from the first position to the third position. Following introduction of the fluid containing the bacteriophage, the valveless microfluidic device 104 can be incubated to facilitate expression of a reporter (e.g., lysate) by bacteria retained by the membrane 210.

For example, the valveless microfluidic device 104 may be used with a microfluidic assay and E. Coli bacteriophage such as described in U.S. patent application Ser. No. 15/870,370 “Microfluidic Platform for the Concentration and Detection of Bacterial Populations in Liquid” filed on Jan. 12, 2018, and as described in U.S. patent application Ser. No. 15/958,931 “Phage Constructs for Detecting Bacteria in a Fluid, Microfluidic Devices for Use with Constructs, and Related Methods” filed on Apr. 20, 2018, each of which are incorporated by reference to the extent not inconsistent herein.

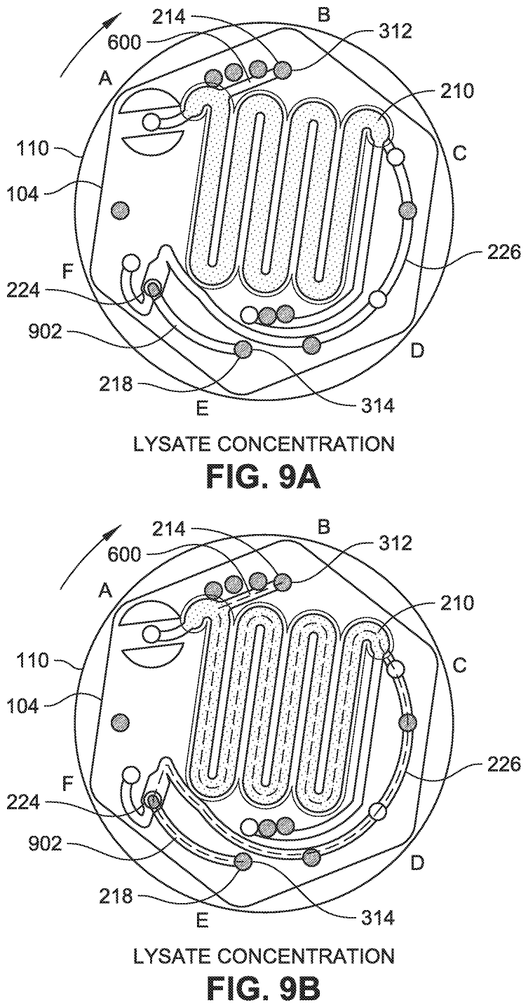

Referring to FIGS. 9A and 9B, the valveless microfluidic device 104 is shown in a fourth position with respect to the lid 110 to facilitate concentration of lysate at the enzyme reporter capture membrane 224 within the valveless microfluidic device 104. In the fourth position, the seventh aperture 312 of the lid 110 is aligned with and in fluid communication with the third aperture 214 of the valveless microfluidic device 104. The eighth aperture 314 of the lid 110 is aligned with and in fluid communication with the fifth aperture 218 of the valveless microfluidic device 104 when the valveless microfluidic device 104 is in the fourth position with respect to the lid 110. In some embodiments, the seventh aperture 312 of the lid 110 is in fluid communication with an atmospheric environment and the eighth aperture 314 of the lid 110 is in fluid communication with a suction device (e.g., a fluid line of the plurality of fluid lines 118) to draw fluid retained by the membrane 110 through the flow channel 226 and through the enzyme reporter capture membrane 224 to concentrate lysate formed within the valveless microfluidic device 104 (e.g., by the presence of bacteria retained by the membrane 210) at the enzyme reporter capture membrane 224, and excess fluid continuing through flow channel 902 in fluid communication with the fifth aperture 218. In embodiments, the system 100 transitions between the third position of the stage 102 and the fourth position of the stage 102 through a clockwise rotation of the stage 102 from the third position to the fourth position.

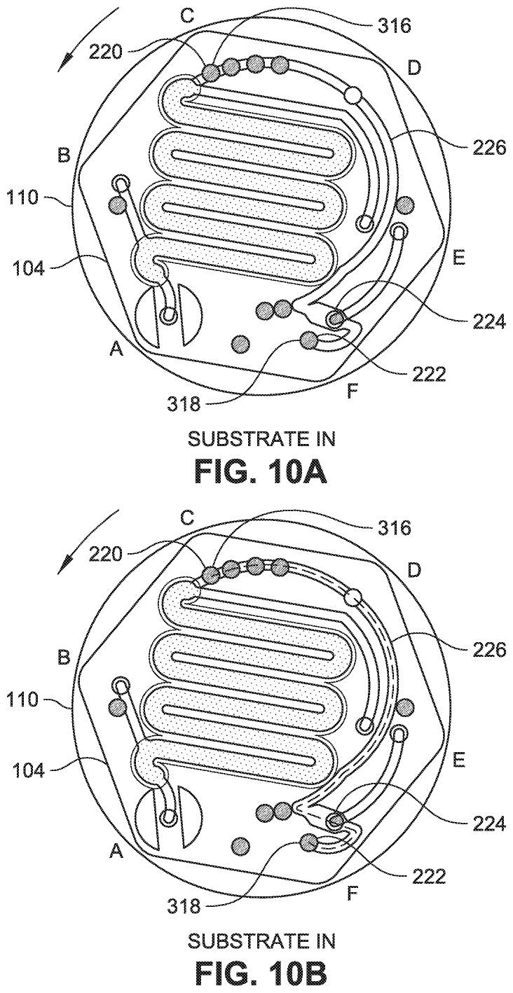

Referring to FIGS. 10A and 10B the valveless microfluidic device 104 is shown in a fifth position with respect to the lid 110 to facilitate passage of a fluid containing a substrate through the enzyme reporter capture membrane 224 within the valveless microfluidic device 104. In the fifth position, the ninth aperture 316 of the lid 110 is aligned with and in fluid communication with the sixth aperture 220 of the valveless microfluidic device 104. The tenth aperture 318 of the lid 110 is aligned with and in fluid communication with the seventh aperture 222 of the valveless microfluidic device 104 when the valveless microfluidic device 104 is in the fifth position with respect to the lid 110. In some embodiments, the ninth aperture 316 of the lid 110 is coupled with a fluid line in fluid communication with a reagent source (e.g., a fluid containing a substrate) and the tenth aperture 318 of the lid 110 is coupled to a suction device (e.g., vacuum source, pump, etc.) via a second fluid line such that fluid is drawn from the reagent source through the first fluid line, through the sixth aperture 220 of the valveless microfluidic device 104, through at least a portion of the flow channel of the valveless microfluidic device 104 in response to application of suction to the second fluid line by the suction device. For example, a fluid containing a substrate can be drawn into the valveless microfluidic device 104 from the reagent source through action of the suction device, where the fluid containing a substrate travels through the sixth aperture 220, into the flow channel 226, over the enzyme reporter capture membrane 224, and out the seventh aperture 222 of the valveless microfluidic device 104 to introduce the substrate to lysate retained by the enzyme reporter capture membrane 224 (e.g., to provide a colored sample having a color distinguishable according to concentration of bacteria present in the initial sample). In embodiments, the system 100 transitions between the fourth position of the stage 102 and the fifth position of the stage 102 through a counterclockwise rotation of the stage 102 from the fourth position to the fifth position. Following introduction of the fluid containing the substrate, the valveless microfluidic device 104 can be transported to a detector to measure the amount of concentration of expressed reporter retained by the enzyme reporter capture membrane 224 to determine an amount or concentration of bacteria initially present in the fluid sample introduced to the valveless microfluidic device 104.

In some embodiments, the system 100 includes one or more indexing sensors to determine a particular position or a relative position of the stage 102, such as a rotational position of the stage 102, a z-axis position of the stage 102, or combinations thereof. For example, referring to FIGS. 11A and 11B, the system can include one or more indexing sensors (sensors 1100a, 1100b, 1100c are shown) positioned to detect the presence or absence of a structural component of the system 100 and to generate a sense signal (or lack thereof) associated with a position of the stage 102 based on the presence or absence of the structural component of the system 100. The sensors 1100a, 1100b, and 1100c can include, but are not limited to, one or more of an optical sensor, a photointerrupter, a microswitch, a proximity sensor, or combinations thereof. In some embodiments, the system 100 includes an indexing structure 1102 coupled to the powered rotating portion 434 of the second motor 124. The indexing structure 1102 includes one or more indexing slots 1104 (e.g., notches) positioned on an edge of the indexing structure 1102. For example, the indexing structure 1102 can include an encoder disk defining a circular shape having the indexing slots 1104 arranged about the outer edge 1106 or circumference of the indexing structure 1102. The system 100 includes at least one indexing sensor positioned adjacent the indexing structure 1102 to register the presence or absence of the one or more indexing slots 1104. The indexing sensors are operable to generate a first sense signal when positioned at the one or more indexing slots 1104 and to generate a second sense signal when positioned at a portion of the indexing structure 1102 lacking the one or more indexing slots 1104. The first sense signal differs from the second sense signal to allow the system 100 to sense a difference in rotational positioning of the stage 102 based on the different sense signals. For example, the indexing sensors 1100a and 1100b are positioned adjacent the outer edge 1106 of the indexing structure 1102 to register the indexing slots 1104 or lack thereof as the powered rotating portion 434 rotates. The indexing sensors can facilitate determination of a starting or zero position of the stage 102 where other movements of the stage are referenced from the starting or zero position (e.g., via counting the indexing slots 1104 during movement of the stage 102). In some embodiments, the indexing sensors 1100a and 1100b include photointerrupters that direct an optical signal toward a detector positioned on an opposite side of the indexing structure 1102, where the optical signal can only reach the detector when passed through one of the indexing slots 1104. The indexing sensors 1100a and 1100b generate a first sense signal when the optical signal is received by the detector and a generate a second sense signal when the optical signal is not received by the detector (or is otherwise obscured).

In some embodiments, the system 100 includes the indexing sensor 1100c to determine a z-axis position of the stage 102. For example, the indexing sensor 1100c can be coupled to the base 108 (e.g., through an aperture 1108 formed in the base 108) to sense the presence or absence of the stage 102 as the stage 102 is moved along the z-axis through operation of the first motor 122. The indexing sensor 1100c is operable to generate a first sense signal when the stage 102 is at a first position via the z-axis motion and to generate a second sense signal when the stage 102 is at a second position via the z-axis motion, wherein the first sense signal differs from the second sense signal. For example, the first position can be a position where the stage 102 is lowered along the z-axis, such as when the stage 102 is to be rotated to align different ports of the lid 110 and the valveless microfluidic device 104, whereas the second position can be a position where the stage 102 is pressed against the lid 110, or otherwise in a position that does not indicate a presence by the indexing sensor 1100c.

Referring to FIG. 12, in some embodiments, the motor system to control the rotational and pistoning motion of the stage 102 is facilitated by a single motor 126 that includes fixed cams to interact with the stage 102. When the motor 126 rotates in a first direction, the cams catch on the stage 102 to move the stage 102 along the z-axis, whereas when the motor 126 rotates in the opposite direction, a ratchet permits rotation of the stage without moving the stage 102 along the z-axis.

Example Water Testing Operation

In an example embodiment, the system 100 can be used for a water testing operation, such as a phage-based detection of E. coli.

Step One. Sample is introduced to the valveless microfluidic device (e.g., valveless microfluidic device 104), either manually or through operation of the system as described with reference to FIGS. 5A and 5B. At least 100 mL of sample is filtered through a PVDF membrane (e.g., membrane 210). Step one proceeds for approximately 5 to 10 minutes, which can depend on sample turbidity (e.g., from 0 to 10 Nephelometric Turbidity Units (NTU)).

Step Two. Bacteria growth media is introduced to the membrane (e.g., as described with reference to FIGS. 6A and 6B). The bacteria growth media includes lysogeny broth to stimulate growth of bacteria retained by the membrane. Approximately 50 to 200 μL of bacteria growth media is introduced. Step two proceeds for up to approximately five seconds.

Step Three. The valveless microfluidic device is incubated at approximately 37° C. for a duration of approximately two hours to stimulate growth of bacteria retained by the membrane.

Step Four. The bacteria growth media is removed from the valveless microfluidic device (e.g., as described with reference to FIGS. 7A and 7B). Approximately 50 to 200 μL of bacteria growth media is removed. Step four proceeds for up to approximately five seconds.

Step Five. Fluid containing a bacteriophage is introduced to the membrane (e.g., as described with reference to FIGS. 8A and 8B).

Approximately 50 to 200 μL of fluid containing the bacteriophage is introduced. Step five proceeds for up to approximately five seconds.

Step Six. The valveless microfluidic device is incubated at approximately 37° C. for a duration of approximately 30 to 45 minutes for cells to express the reporter (e.g., lysate). The incubation can be performed in the system 100, such as through operation of the thermal regulation device 138 to transfer heat to, remove heat from, or combinations thereof, the valveless microfluidic device 104, where the valveless microfluidic device 104 can be maintained on the stage 102 during incubation. Alternatively or additionally, the valveless microfluidic device 104 can be removed from the system 100 for incubation in a separate device or system.

Step Seven. The valveless microfluidic device is flushed to a capture membrane (e.g., nitrocellulose capture membrane), such as described with reference to FIGS. 9A and 9B. Step seven proceeds for approximately 5 to 20 minutes.

Step Eight. A fluid containing a substrate diluted in buffer is introduced to the capture membrane to colorize the expressed reporter. Approximately 5 to 20 μL of fluid containing the substrate diluted in buffer is introduced. Step eight proceeds for up to approximately five seconds.

Step Nine. The valveless microfluidic device is transported to a detector to measure a signal corresponding to the amount of expressed reporter that is colorized. Step nine lasts for up to approximately one minute.

One skilled in the art will recognize that the herein described component, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, devices, and objects should not be taken as limiting.

With respect to the use of substantially any plural and/or singular terms herein, the plural can be translated to the singular and/or from the singular to the plural as is appropriate to the context and/or application. The various singular/plural permutations are not expressly set forth herein for sake of clarity.

In some instances, one or more components can be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

While particular aspects of the present subject matter described herein have been shown and described, changes and modifications can be made without departing from the subject matter described herein and its broader aspects and, therefore, the appended claims are to encompass within their scope all such changes and modifications as are within the true spirit and scope of the subject matter described herein. Terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). If a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). Typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A system comprising:
a stage having an upper surface of a size and a shape to support a valveless microfluidic device, the stage having a bottom surface coupled with an extension extending from the bottom surface, the extension having a threaded portion on an exterior surface of the extension, the extension defining an interior volume;
a first motor including a powered rotating portion operable to engage with the threaded portion of the extension of the stage to induce a z-axis motion of the stage in response to rotation of the powered rotating portion;
a second motor including a powered rotating portion coupled with a slidable coupler, the slidable coupler engaging the interior volume of the extension of the stage to induce a second motion of the stage about the z-axis in response to rotation of the powered rotating portion of the second motor;
a base coupled with the first motor and the second motor, the base defining an aperture to receive the stage within at least a portion of the aperture; and
a lid moveably coupled to the base, the lid positionable to cover the aperture of the base in a closed position, the lid defining a plurality of apertures, a subset of the plurality of apertures corresponding to a subset of a plurality of apertures defined by the valveless microfluidic device upon positioning of the stage by the first motor and the second motor.

2. The system of claim 1, wherein the first motor is operable to induce the z-axis motion of the stage in response to rotation of the powered rotating portion of the first motor and lack of rotation of the powered rotating portion of the second motor.

3. The system of claim 1, wherein the first motor and the second motor are operable to induce the second motion of the stage without the z-axis motion of the stage in response to rotation of the powered rotating portion of the first motor and rotation of the powered rotating portion of the second motor.

4. (canceled)

5. (canceled)

6. The system of claim 1, wherein the first motor and the second motor are operable to induce each of the second motion of the stage and the z-axis motion of the stage in response to rotation of the powered rotating portion of the first motor and rotation of the powered rotating portion of the second motor.

7.-9. (canceled)

10. The system of claim 1, wherein the powered rotating portion of the first motor includes
a pulley having an interior surface defining an aperture, the interior surface having a threading pattern corresponding to the threaded portion of the extension of the stage, and
a belt coupled between the pulley and the first motor to rotate the pulley in response to rotation of the powered rotating portion of the first motor to induce the z-axis motion of the stage.

11.-29. (canceled)

30. The system of claim 1, wherein the stage includes a support wall arranged around at least a portion of the upper surface of the stage, the support wall having a size and a shape to friction fit the valveless microfluidic device on the upper surface of the stage.

31. (canceled)

32. (canceled)

33. The system of claim 1, wherein the stage includes a projection extending from the upper surface of the stage, the projection having a size and a shape to conform to a positioning aperture formed by the valveless microfluidic device to align the valveless microfluidic device on the stage.

34. The system of claim 1, further comprising at least one indexing sensor operable to generate a sense signal associated with a position of the stage.

35.-52. (canceled)

53. A system comprising:
a valveless microfluidic device having
a top planar surface and a bottom planar surface,
a plurality of fluid inlet ports and a plurality of fluid outlet ports in the top planar surface and in fluid communication with a flow channel passing between the top planar surface and the bottom planar surface; and
a fluid handling system having
a stage having an upper surface of a size and a shape to support the valveless microfluidic device, the stage having a bottom surface coupled with an extension extending from the bottom surface, the extension having a threaded portion on an exterior surface of the extension, the extension defining an interior volume,
a first motor including a powered rotating portion operable to engage with the threaded portion of the extension of the stage to induce a z-axis motion of the stage in response to rotation of the powered rotating portion,
a second motor including a powered rotating portion coupled with a slidable coupler, the slidable coupler engaging the interior volume of the extension of the stage to induce a second motion of the stage about the z-axis in response to rotation of the powered rotating portion of the second motor,
a base coupled with the first motor and the second motor, the base defining an aperture to receive the stage within at least a portion of the aperture,
a lid moveably coupled to the base, the lid positionable to cover the aperture of the base in a closed position, the lid defining a plurality of apertures, a subset of the plurality of apertures corresponding to a subset of each of the plurality of fluid inlet ports and the plurality of fluid outlet ports upon positioning of the stage by the first motor and the second motor.

54. (canceled)

55. (canceled)

56. The system of claim 53, wherein a first aperture of the lid is in fluid communication with a first aperture of the valveless microfluidic device, and a second aperture of the lid is in fluid communication with a second aperture of the valveless microfluidic device, when the valveless microfluidic device is in a first position with respect to the lid.

57. The system of claim 56, further comprising
a first fluid line in fluid communication with the first aperture of the lid, the first fluid line having a size and a shape to interface with a reagent source; and
a second fluid line in fluid communication with the second aperture of the lid, the second fluid line having a size and a shape to interface with a suction device,
wherein fluid is drawn from the reagent source through the first fluid line, through the first aperture of the valveless microfluidic device, through at least a portion of the flow channel of the valveless microfluidic device in response to application of suction to the second fluid line.

58. (canceled)

59. The system of claim 56, wherein a third aperture of the lid is in fluid communication with a third aperture of the valveless microfluidic device, and a fourth aperture of the lid is in fluid communication with a fourth aperture of the valveless microfluidic device, when the valveless microfluidic device is in a second position with respect to the lid.

60. (canceled)

61. (canceled)

62. The system of claim 59, wherein a fifth aperture of the lid is in fluid communication with the third aperture of the valveless microfluidic device, and a sixth aperture of the lid is in fluid communication with the fourth aperture of the valveless microfluidic device, when the valveless microfluidic device is in a third position with respect to the lid.

63. (canceled)

64. (canceled)

65. The system of claim 62, wherein a seventh aperture of the lid is in fluid communication with the third aperture of the valveless microfluidic device, and an eighth aperture of the lid is in fluid communication with a fifth aperture of the valveless microfluidic device, when the valveless microfluidic device is in a fourth position with respect to the lid.

66. (canceled)

67. The system of claim 65, wherein a ninth aperture of the lid is in fluid communication with a sixth aperture of the valveless microfluidic device, and a tenth aperture of the lid is in fluid communication with a seventh aperture of the valveless microfluidic device, when the valveless microfluidic device is in a fifth position with respect to the lid.

68.-114. (canceled)

115. The system of claim 1, wherein the slidable coupler includes one or more facets on an outer surface, and wherein the interior volume of the extension includes one or more complementary facets of a size and a shape to match the one or more facets of the slidable coupler when the slidable coupler is received within the interior volume of the extension.

116. The system of claim 1, wherein the plurality of apertures of the lid include a plurality of inlet ports and a plurality of outlet ports, and wherein the system further includes
a first fluid line coupled to an inlet port of the plurality of inlet ports, the first fluid line having a size and a shape to interface with a reagent source; and
a second fluid line coupled to an outlet port of the plurality of outlet ports, the second fluid line having a size and a shape to interface with a suction device,
wherein fluid is drawn from the reagent source through the first fluid line, through a first aperture of the subset of the plurality of apertures defined by the valveless microfluidic device, through at least a portion of a flow channel of the valveless microfluidic device, in response to application of suction to the second fluid line.

117. The system of claim 34, wherein the at least one indexing sensor includes at least one of an optical sensor, a photointerrupter, one or more microswitches, or a proximity sensor.

118. The system of claim 1, wherein the second motor includes an indexing structure coupled to the powered rotating portion of the second motor, the indexing structure defining one or more indexing slots therethrough, and wherein the system further includes an indexing sensor positioned adjacent the indexing structure.

119. The system of claim 1, further comprising an indexing sensor coupled to the base, the indexing sensor operable to generate a sense signal associated with a position of the stage, wherein the indexing sensor is operable to generate a first sense signal when the stage is at a first position via the z-axis motion and to generate a second sense signal when the stage is at a second position via the z-axis motion, wherein the first sense signal differs from the second sense signal.
